(19) United States
(12) Patent Application Publication
(10) Pub. No.: US 2020/0231076 A1
(43) Pub. Date: Jul. 23, 2020

(54) POWERED HEAD RESTRAINT FOR A VEHICLE

(71) Applicant: GM GLOBAL TECHNOLOGY OPERATIONS LLC, Detroit, MI (US)

(72) Inventors: Gerard Kapolnek, Carleton, MI (US); Chad C. Cairns, Oakland Township, MI (US)

(21) Appl. No.: 16/253,578

(22) Filed: Jan. 22, 2019

(51) Int. Cl. B60N 2/879; B60N 2/809; B60R 16/03

(52) U.S. Cl. CPC B60N 2/879; B60R 16/03; B60N 2/809

(57) ABSTRACT

A powered head restraint assembly for a vehicle includes a head restraint, a seat back, a sleeve in the seat back, and a head restraint support post extending from the head restraint and received by the sleeve in the seat back. The head restraint support post includes a conductive strip on an outer surface of the head restraint support post in contact with a conductive contact in the sleeve to establish an electrical connection between the conductive strip and the conductive contact.

### FIELD

The present disclosure relates to a powered head restraint for a vehicle.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Conventional powered head restraint systems rely upon a complicated and difficult assembly process. FIG. 1 illustrates a conventional powered head restraint system 100 which includes a seat back 102 with a pair of sleeves 104 upward through which a corresponding pair of male electrical connectors 106 extend. The system 100 further includes a head restraint 108 which incorporates a hollow support post 110 which includes two downwardly extending ends 112 through which a pair of wires 114 which each connect to a corresponding pair of female electrical connectors 116 that extend from the ends 112 of the hollow support post 110. In order to assemble the powered head restraint system 110 an assembler is required to hold the head restraint 108 in position above the seat back 102 while another assembler connects the pair of female electrical connectors 116 to the corresponding pair of male electrical connectors 106. Next, while the assembler holding the head restraint 108 gradually moves the head restraint 108 downward to position the downwardly extending ends 112 of the hollow support post 110 into the sleeves 104, another assembler must simultaneously route the connected female and male connectors 106/116 and the wiring extending therefrom downward into the corresponding sleeves 104. This is a complex and challenging operation for the assemblers.

This assembly operation is further complicated because, as is clearly illustrated by FIGS. 3 and 4, the female and male connectors 106/116 must both be sized and configured to reliably make and maintain the electrical connection while being capable of fitting into an internal cavity 118 of the sleeves 104.

### SUMMARY

In an exemplary aspect, a powered head restraint assembly for a vehicle includes a head restraint, a seat back, a sleeve in the seat back, and a head restraint support post extending from the head restraint and received by the sleeve in the seat back. The head restraint support post includes a conductive strip on an outer surface of the head restraint support post in contact with a conductive contact in the sleeve to establish an electrical connection between the conductive strip and the conductive contact.

In another exemplary aspect, the conductive strip on the outer surface of the head restraint includes a channel in the outer surface of the head restraint support post.

In another exemplary aspect, the channel longitudinally extends along a length of the head restraint support post.

In another exemplary aspect, the conductive strip further includes an insulative coating in the channel.

In another exemplary aspect, the conductive strip further includes a conductive material in the conductive strip.

In another exemplary aspect, the conductive contact in the sleeve includes an electrically conductive guide sleeve on an internal surface of the sleeve.

In another exemplary aspect, the head restraint support post includes a plurality of conductive strips on the outer surface of the head restraint support post.

In another exemplary aspect, the conductive contact in the sleeve includes an end connector releasably connected to an end of the sleeve.

In another exemplary aspect, the end connector includes a first cylindrical portion, a second cylindrical portion, and a landing between the first cylindrical portion and the second cylindrical portion.

In another exemplary aspect, the first cylindrical portion radially extends a distance that is greater than a radius of an internal surface of a cylindrical cavity in the support post.

In another exemplary aspect, the second cylindrical portion radially extends a distance that is less than a radius of an internal surface of a cylindrical cavity in the support post.

In another exemplary aspect, the end connector further includes a conductive finger extending from the first cylindrical portion across the landing and spaced from an outside radial surface of the second cylindrical portion.

In another exemplary aspect, the conductive finger contacts the conductive strip on the support post to form the electrical connection between the conductive strip and the conductive contact.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of powered head restraint system;

FIG. 2 is another perspective view of the powered head restraint system of FIG. 1;

FIG. 3 is a perspective view of a seat back sleeve and female connector of the powered head restraint system of FIG. 1;

FIG. 4 is a plan view of the seat back sleeve and female connector of FIG. 3;

FIG. 5 is a perspective view of an exemplary powered head restraint system in accordance with the present disclosure;

FIG. 6 is another perspective view of the powered head restraint system of FIG. 5;

FIG. 7 is a close-up perspective view of the powered head restraint system of FIGS. 5 and 6;

FIG. 8 is another perspective view of the powered head restraint system of FIG. 5;

FIG. 9 is a cross-sectional view of the powered head restraint system of FIG. 8;

FIG. 10 is a perspective view of another powered head restraint system in accordance with the present disclosure;

FIG. 11 is a close-up perspective view of a male connector of the powered head restraint system of FIG. 10; and

FIG. 12 is a cross-sectional view of the powered head restraint system of FIGS. 10 and 11.

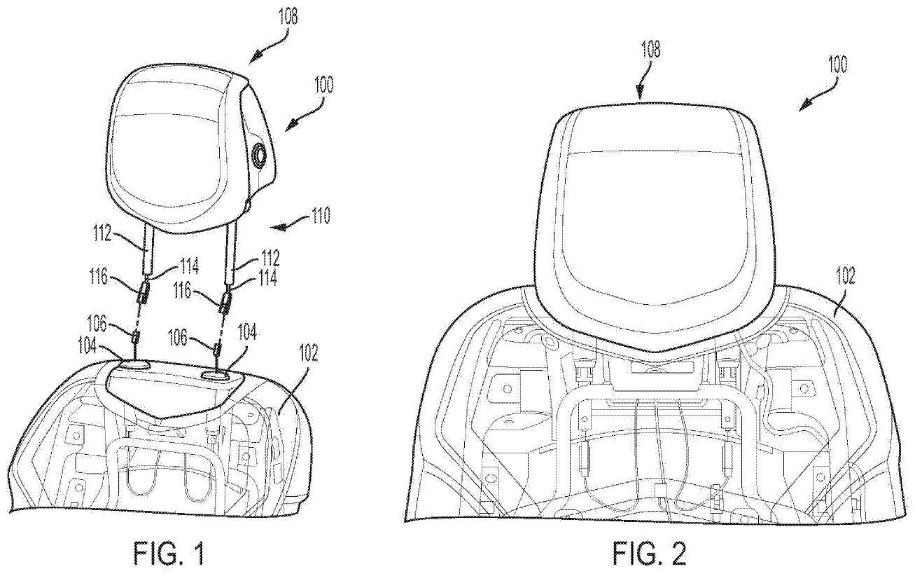

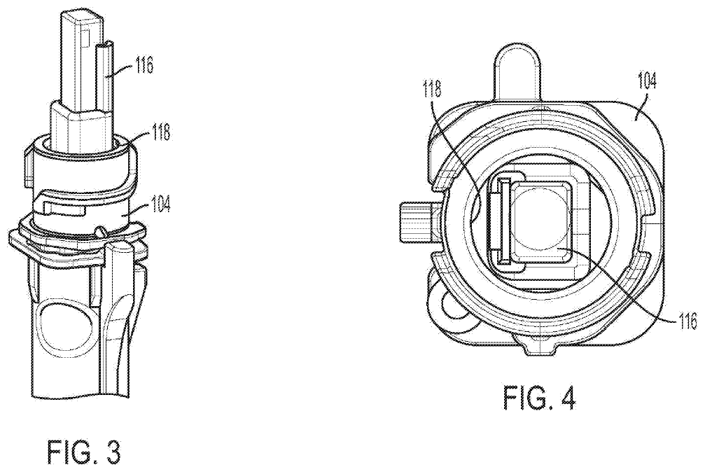

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

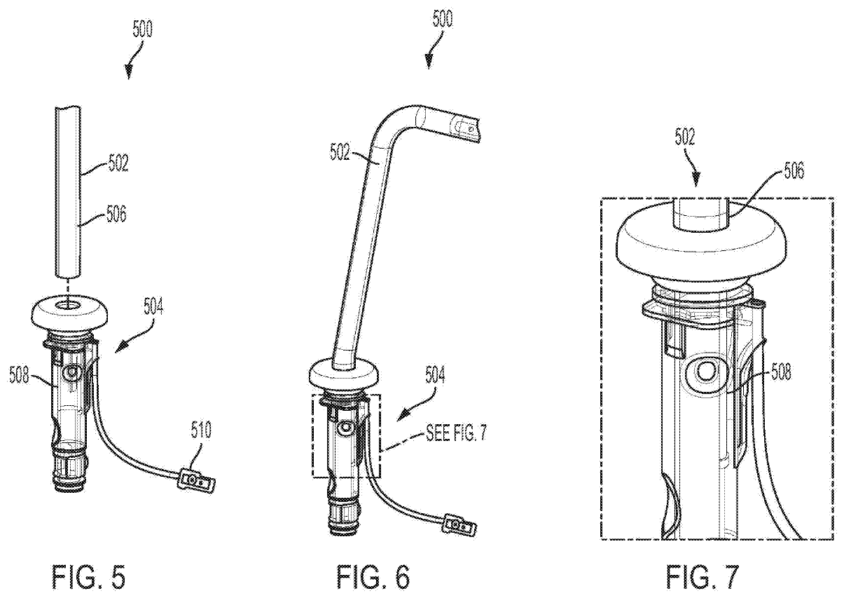

FIG. 5 is a perspective view of an exemplary powered head restraint system 500 in accordance with the present disclosure. The powered head restraint system 500 includes a head restraint support post 502 and a seat back sleeve 504. The head restraint support post 502 is configured to provide support to a head restraint (not shown) and the seat back sleeve 504 is adapted to be received in a seat back (not shown). The head restraint support post 502 includes a power strip 506 that, when installed into the seat back sleeve 504 as illustrated in FIG. 6 and close-up in FIG. 7, establishes an electrical connection with a corresponding power connection 508 in the sleeve 504. The power connection 508 may be wired to a connector 510 which may be further connected to a power supply within the seat back.

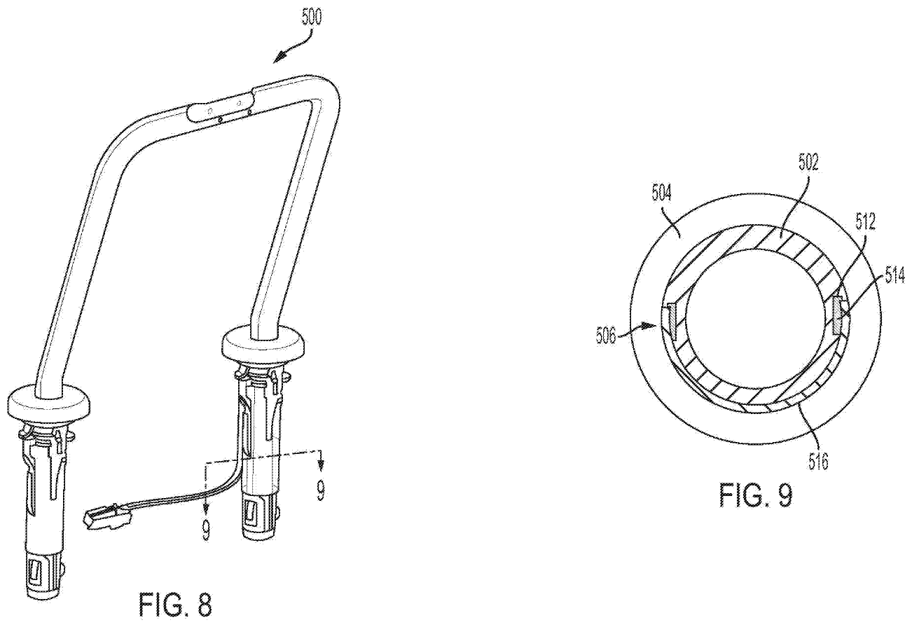

FIG. 8 provides another perspective view of the powered head restraint system 500 and FIG. 9 is a cross-sectional view of the system 500 taken along line A-A in FIG. 8. The head restraint support post 502 includes a power strip 506. The power strip 506 may be formed by providing a longitudinally-extending channel along a portion of the length of the support post 502 and that extends at least partially radially into support post 502 from an outer surface. An insulating layer 512 may preferably be applied in the channel to insulate the support post 502 from the electrical connection. The power strip 506 also includes a conductive material 514, such as, for example, a copper material or the like, which provides an electrically conductive path along the channel. The seat back sleeve 504 includes an electrically conductive guide sleeve 516 on an internal surface of the sleeve 504 that establishes an electrical connection between the guide sleeve 516 and the power strip 506. The guide sleeve 516 is also connected to a source of electrical energy which may be provided by the wired connector 510. In this manner, a reliable electrical connection may be provided by installation of the support post 502 into the seat back sleeve 504 without requiring separate connections to be established. This significantly reduces the cost and workload of those assembling a powered head restraint in accordance with the present disclosure.

While the exemplary powered head restraint system 500 illustrated in FIGS. 5-9 include a power strip 506 on each side of the head restraint support post 502, it is understood that a head restraint support post may incorporate any number of power strips and remain within the scope of the present invention.

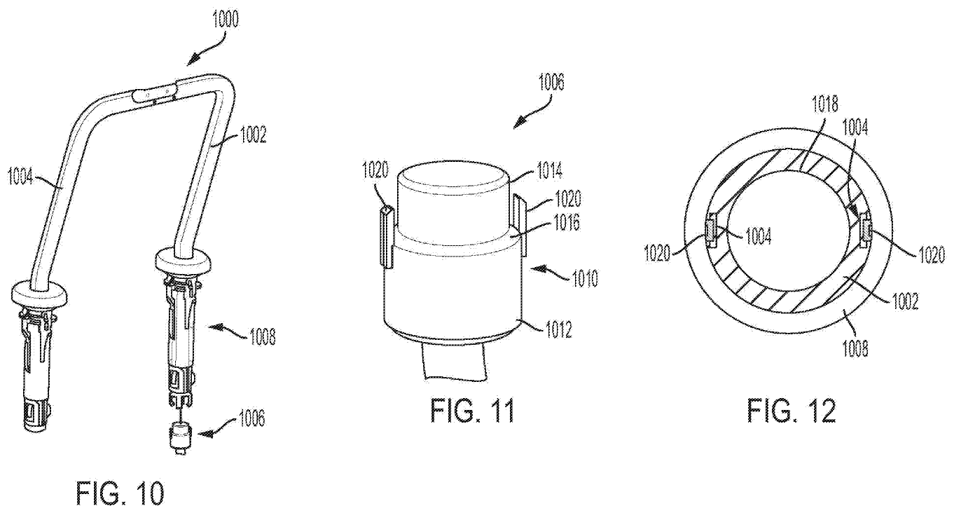

FIGS. 10-12 illustrate another powered head restraint system 1000 in accordance with the present disclosure. The powered head restraint system 1000 provides another exemplary system for establishing an electrical connection between a power source and the head restraint support post 1002. The head restraint support post 1002 includes a power strip 1004 that is the same as that described previously with reference to the exemplary embodiment illustrated in FIGS. 5-9. However, a distinctive feature of the electrical connection is that the power strip 1004 extends to an end of the support post 1002 and electrically connects with an end connector 1006 when the support post 1002 is installed into the seat back sleeve 1008. The end connector 1006 includes a connector body 1010 which includes a first cylindrical portion 1012, a second cylindrical portion 1014, and a landing 1016 between the first cylindrical portion 1012 and the second cylindrical portion 1014. The first cylindrical portion 1012 radially extends a distance which is greater than a radius of the internal cylindrical cavity 1018 of the support post 1002 such that the landing 1016 provides a surface against which an end of the support post 1002 may contact when installed into the sleeve 1008. The second cylindrical portion 1014 has a radial extent which is less than the radius of the internal cylindrical cavity 1018 of the support post 1002 such that the second cylindrical portion 1014 extends into the internal cylindrical cavity 1018 when the support post 1002 is installed into the sleeve 1008. In this manner, the second cylindrical portion 1014 may act as a guide for positioning the support post 1002 relative to the end connector 1006.

The end connector 1006 further includes a pair of electrically conductive fingers 1020 that each extend from the first cylindrical portion 1012, across the landing 1016 and spaced from an outside radial surface of the second cylindrical portion 1014. Each of the fingers 1020 are radially positioned such that when the support post 1002 is installed in the sleeve 1008 that each of the fingers 1020 come into contact with and, thereby, establish an electrical connection with a corresponding power strip 1004 on the support post 1002.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A powered head restraint assembly for a vehicle, the assembly comprising
a head restraint;
a seat back;
a sleeve in the seat back; and
a head restraint support post extending from the head restraint and received by the sleeve in the seat back, the head restraint support post comprising a conductive strip on an outer surface of the head restraint support post in contact with a conductive contact in the sleeve to establish an electrical connection between the conductive strip and the conductive contact.

2. The assembly of claim 1, wherein the conductive strip on the outer surface of the head restraint comprises a channel in the outer surface of the head restraint support post.

3. The assembly of claim 2, wherein the channel longitudinally extends along a length of the head restraint support post.

4. The assembly of claim 2, wherein the conductive strip further comprises an insulative coating in the channel.

5. The assembly of claim 2, wherein the conductive strip further comprises a conductive material in the conductive strip.

6. The assembly of claim 1, wherein the conductive contact in the sleeve comprises an electrically conductive guide sleeve on an internal surface of the sleeve.

7. The assembly of claim 1, wherein the head restraint support post comprises a plurality of conductive strips on the outer surface of the head restraint support post.

8. The assembly of claim 1, wherein the conductive contact in the sleeve comprises an end connector releasably connected to an end of the sleeve.

9. The assembly of claim 8, wherein the end connector comprises:
a first cylindrical portion;
a second cylindrical portion; and
a landing between the first cylindrical portion and the second cylindrical portion.

10. The assembly of claim 9, wherein the first cylindrical portion radially extends a distance that is greater than a radius of an internal surface of a cylindrical cavity in the support post.

11. The assembly of claim 9, wherein the second cylindrical portion radially extends a distance that is less than a radius of an internal surface of a cylindrical cavity in the support post.

12. The assembly of claim 9, wherein the end connector further comprises a conductive finger extending from the first cylindrical portion across the landing and spaced from an outside radial surface of the second cylindrical portion.

13. The assembly of claim 12, wherein the conductive finger contacts the conductive strip on the support post to form the electrical connection between the conductive strip and the conductive contact.

14. A vehicle including a powered head restraint assembly, the head restraint assembly comprising:
a head restraint;
a seat back;
a sleeve in the seat back;
a head restraint support post extending from the head restraint and received by the sleeve in the seat back, the head restraint support post comprising a conductive strip on an outer surface of the head restraint support post in contact with a conductive contact in the sleeve to establish an electrical connection between the conductive strip and the conductive contact.

15. The vehicle of claim 14, wherein the channel longitudinally extends along a length of the head restraint support post and wherein the conductive strip on the outer surface of the head restraint comprises:
a channel in the outer surface of the head restraint support post;
an insulative coating in the channel; and
a conductive material in the conductive strip.

16. The vehicle of claim 14, wherein the conductive contact in the sleeve comprises an electrically conductive guide sleeve on an internal surface of the sleeve.

17. The vehicle of claim 14, wherein the conductive contact in the sleeve comprises an end connector releasably connected to an end of the sleeve.

18. The vehicle of claim 17, wherein the end connector comprises:
a first cylindrical portion;
a second cylindrical portion; and
a landing between the first cylindrical portion and the second cylindrical portion.

19. The vehicle of claim 18, wherein the first cylindrical portion radially extends a distance that is greater than a radius of an internal surface of a cylindrical cavity in the support post, and wherein the second cylindrical portion radially extends a distance that is less than a radius of an internal surface of a cylindrical cavity in the support post.

20. The vehicle of claim 18, wherein the end connector further comprises a conductive finger extending from the first cylindrical portion across the landing and spaced from an outside radial surface of the second cylindrical portion, and wherein the conductive finger contacts the conductive strip on the support post to form the electrical connection between the conductive strip and the conductive contact.
